(19) United States
(12) Patent Application Publication
(10) Pub. No.: US 2025/0377633 A1
(43) Pub. Date: Dec. 11, 2025

(54) MOON PHASE AND EARTH PHASE DISPLAY DEVICE FOR A HOROLOGICAL MOVEMENT

(71) Applicant: ETA SA MANUFACTURE HORLOGÈRE SUISSE, Grenchen (CH)

(72) Inventors: Ivan VILLAR, Brügg (CH); Raphaël COURVOISIER, Corcelles (CH)

(73) Assignee: ETA SA MANUFACTURE HORLOGÈRE SUISSE, Grenchen (CH)

(21) Appl. No.: 19/206,532

(22) Filed: May 13, 2025

(30) Foreign Application Priority Data
Jun. 5, 2024 (EP) 24180118.2

(51) Int. Cl. G04B 19/26; G04B 13/02; G04B 19/04; G04B 19/20

(52) U.S. Cl. CPC G04B 19/268; G04B 13/02; G04B 19/046; G04B 19/048; G04B 19/202

(57) ABSTRACT

A Moon phase and Earth phase display device (100) for a horological movement, which device includes a display (110) including a plurality of graphical representations (120) symbolising respectively different successive phases of a celestial body, a dial (130) provided with two apertures (131) arranged so as to concomitantly display two diametrically opposed graphical representations (120), one of which symbolises a Moon phase and the other of which symbolises an Earth phase, and a drive mechanism (140) configured to drive the display (110) in sequential movement.

### CROSS REFERENCE TO RELATED APPLICATIONS

This application claims priority to European Patent Application No. 24180118.2 filed Jun. 5, 2024, the entire contents of which are incorporated herein by reference.

### TECHNICAL FIELD OF THE INVENTION

The invention relates to the field of watchmaking and in particular to devices for displaying a time variable on a timepiece.

More particularly, the invention relates to a device for displaying a Moon phase and an Earth phase for a horological movement of a watch.

### TECHNOLOGICAL BACKGROUND

Moon phase displays are well known in the watchmaking industry, as are Earth phase displays, i.e. the display of the part of the Earth visible from the Moon.

Moon or Earth phase display devices add considerable complexity to the horological movement in which they are integrated.

Moreover, for aesthetic reasons, concomitant display of the Moon and Earth phases may be desired.

The invention meets this need, while simplifying as far as possible the kinematics for simultaneously displaying the phases of the Moon and Earth.

### SUMMARY OF THE INVENTION

To this end, the invention relates to a Moon phase and Earth phase display device for a horological movement. The display device comprises a display comprising a plurality of graphical representations symbolising respectively different successive phases of a celestial body, a dial provided with two apertures arranged so as to concomitantly display two graphical representations, one of which symbolises a Moon phase and the other of which symbolises an Earth phase, and a drive mechanism configured to drive the display in sequential movement.

In particular embodiments, the invention can further include one or more of the following features, which must be considered singly or according to any combination technically possible.

In particular embodiments, the display takes the form of a ring and comprises a plurality of graphical representations and an equal number of teeth via which the display is intended to be driven by the drive mechanism in a sequential movement.

In particular embodiments, the display takes the form of a ring and comprises thirty graphical representations and thirty teeth via which the display is intended to be moved by the drive mechanism at a rate of one step per day, the two apertures being arranged diametrically opposite each other.

In particular embodiments, at least one of the apertures comprises an aperture glass giving the graphical representation a different appearance from that of the graphical representation visible in the other aperture.

In particular embodiments, in which the graphical representations of the display are transparent or translucent, so that a decoration, arranged facing a side of the display opposite the dial, is visible through one or each of the apertures, allowing the Moon phase to be distinguished from the Earth phase in the apertures.

In particular embodiments, the one or more decorations are in the form of a coloured surface.

In particular embodiments, the drive mechanism comprises an hour wheel of a motion-work train, to which a transmission wheel is kinematically connected via an intermediate wheel, the transmission wheel being intended to cooperate, by means of a driving finger-piece which it carries, with teeth of the display.

In particular embodiments, the display device comprises a correction mechanism provided with a control member configured to be kinematically linked with a corrector via a train of intermediate wheels.

The present invention further relates to a watch comprising a horological movement provided with a device for displaying a Moon phase and an Earth phase as described above.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a front view of a watch comprising a Moon phase and Earth phase display device according to one example embodiment of the invention,

FIG. 2 shows a perspective view of the watch in FIG. 1, in which components have been masked to reveal the display device.

It should be noted that the figures are not necessarily drawn to scale for reasons of clarity.

### DETAILED DESCRIPTION OF THE INVENTION

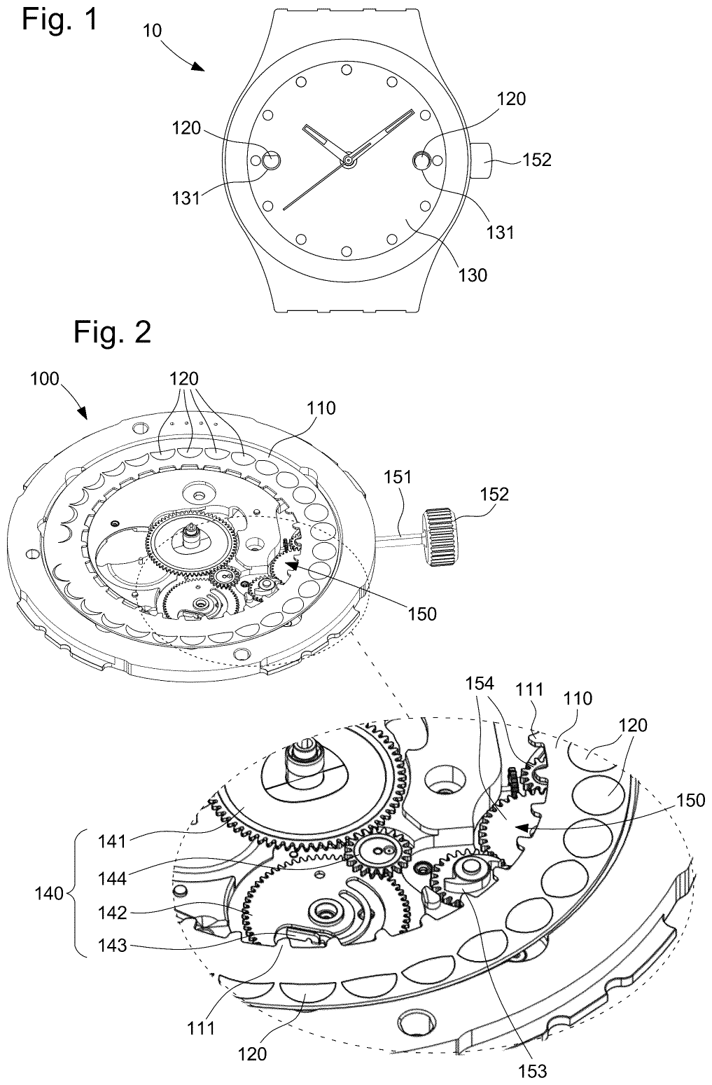

FIG. 1 shows a watch 10 comprising a horological movement provided with a device 100 for displaying a Moon phase and an Earth phase according to the invention.

In the example embodiment of the invention shown in the figures, the display device 100 comprises a display 110 in the form of a ring comprising a plurality of graphical representations 120 respectively symbolising various successive phases of a celestial body. The celestial body represents the Earth or the Moon, as described in more detail below.

In the preferred example embodiment of the invention, and as shown in FIG. 2, the display 110 preferably has thirty graphical representations 120. More specifically, as indicated below, the display 110 is intended to be rotated sequentially at a rate of one step per day so as to complete one revolution every thirty days.

Alternatively, it can be envisaged that the display 110 has fewer than thirty graphical representations 120, for example twenty-eight or twenty-nine, or more than thirty, for example thirty-one.

The display device 100 comprises a dial 130, shown in FIG. 1, arranged above the display 110 so as to mask all of the graphical representations 120 except for two, diametrically opposed, visible through the apertures 131 provided in the dial 130. More specifically, the dial 130 is provided with two apertures 131 arranged so that two diametrically opposed graphical representations 120 appear simultaneously, one of which symbolises a Moon phase and the other of which symbolises an Earth phase.

It should be noted that the apertures 131, and thus the visible graphical representations 120, are arranged such that they are diametrically opposed, i.e. such that they form an angle of 180 degrees when the display has an even number of graphical representations 120.

By way of example, one of the apertures 131 can comprise an aperture glass giving the graphical representation 120 a different appearance from that of the graphical representation 120 visible in the other aperture 131, so that a user can differentiate between the Moon phase and the Earth phase. To this end, the aperture glass can have a tint, for example blue or grey, or the aperture glass can have a decoration or marking symbolising continents or craters.

It is also possible for a decoration to be made on the dial 130, close to at least one of the apertures 131, for example at the periphery thereof, in order to indicate in which aperture 131 the Moon phase or respectively the Earth phase is represented.

It is also possible for this or these decorations to be present under the display 110, i.e. facing a side of the display 110 opposite the dial 130, and to be visible through the one or more apertures 131. The one or more decorations are, for example, in the form of a coloured surface, for example formed by a disc that may or may not be luminous. In this case, the graphical representations 120 are transparent or translucent. In particular, they can be formed by cuts going through the display 110.

In FIG. 1, the apertures 131 have a circular shape corresponding to the shape of the graphical representation 120 symbolising a phase of a solid celestial body. However, the apertures 131 can be of any shape and size that is suitable for viewing the graphical representations 120.

The graphical representations 120 are arranged so that they are evenly distributed around the display 110 so that two diametrically opposed graphical representations 120 symbolise opposing phases, as shown in FIG. 2. More specifically, the frequency of appearance of Moon phases is identical to that of Earth phases, and the Moon and Earth phases are exactly opposite. In other words, when the surface of the Moon visible from the Earth decreases, the surface of the Earth visible from the Moon increases in identical proportions, and vice-versa.

In order to move the display 110, the display device 100 has a drive mechanism 140 preferably consisting of a date drive mechanism. In particular, as shown in FIG. 2, the drive mechanism 140 comprises an hour wheel 141 of a motion-work train, rotated, for example, by two revolutions per day, in a manner known in the prior art. The drive mechanism 140 further comprises a transmission wheel 142 kinematically connected to the hour wheel 141 by an intermediate wheel 144 in the example embodiment of the invention shown in FIG. 2. The transmission wheel 142 is intended to cooperate with the display 110 via a driving finger-piece 143, in particular with teeth 111 provided on the periphery of the display 110 as shown in FIG. 2.

The toothing of the display 110 has as many teeth 111 as there are graphical representations 120, so that for each step made by the display 110, a new graphical representation 120 is visible through the apertures 131. In the example embodiment shown in FIG. 2, the toothing of the display 110 is arranged on the inner periphery thereof; however, it could also be arranged on the outer periphery thereof. Preferably, as shown in FIG. 2, in order to be driven so as to make one revolution for every thirty steps, the toothing of the display 110 comprises thirty teeth 111.

In this case, the display 110 is driven sequentially. However, the display can be driven continuously by replacing the driving finger-piece 143 with a toothed wheel meshing with the toothing of the display 110.

Conventionally, the stability of the position of the display 110 is guaranteed by a jumper, not shown in the figures, cooperating with the teeth 111.

Advantageously, the display device 100 can comprise a correction mechanism 150 provided with a control member formed, in the example embodiment of the invention shown in the figures, by a winding stem 151 linked to a winding button 152. The winding stem 151 is configured to be kinematically linked to a corrector 153 by means of a train of intermediate wheels 154. Such a correction mechanism 150 is shown in the figures but is not described in detail in the text because it is well known as such to a person skilled in the art.

The present invention advantageously makes it possible to take advantage of an existing design of a watch with a date display. This is because, in order to be implemented, the invention requires minimal adaptation, only requiring the dial 130 and the display 110 of the watch to be replaced. Moreover, thanks to the features of the invention, a fast date correction mechanism can be easily adapted to correct the Moon and Earth phases.

More generally, it should be noted that the implementations and embodiments considered above have been described by way of non-limiting examples, and that other alternatives are consequently possible.

It should be noted that, for reasons of clarity, the components of the horological movement known to a person skilled in the art are not described in this text and do not appear in the figures.

1. A moon phase and Earth phase display device (100) for a horological movement, characterised in that it comprises a display (110) comprising a plurality of graphical representations (120) symbolising respectively different successive phases of a celestial body, a dial (130) provided with two apertures (131) arranged so as to concomitantly display two graphical representations (120), one of which symbolises a Moon phase and the other of which symbolises an Earth phase, and a drive mechanism (140) configured to move the display (110).

2. The display device (100) according to claim 1, wherein the display (110) takes the form of a ring and comprises a plurality of graphical representations (120) and an equal number of teeth (111) via which the display (110) is intended to be driven by the drive mechanism (140) in a sequential movement.

3. The display device (100) according to claim 1, wherein the display (110) takes the form of a ring and comprises thirty graphical representations (120) and thirty teeth (111) via which the display (110) is intended to be moved by the drive mechanism (140) at a rate of one step per day, the two apertures (131) being arranged diametrically opposite each other.

4. The display device (100) according to claim 1, wherein at least one of the apertures (131) comprises an aperture glass giving the graphical representation (120) a different appearance from that of the graphical representation (120) visible in the other aperture (131).

5. The display device (100) according to claim 1, wherein the graphical representations (120) of the display (110) are transparent or translucent, so that a decoration, arranged facing a side of the display (110) opposite the dial (130), is visible through one or each of the apertures (131), allowing the Moon phase to be distinguished from the Earth phase in the apertures (131).

6. The display device (100) according to claim 5, wherein the one or more decorations are in the form of a coloured surface.

7. The display device (100) according to claim 1, wherein the drive mechanism (140) comprises an hour wheel (141) of a motion-work train, to which a transmission wheel (142) is kinematically connected via an intermediate wheel (144), the transmission wheel (142) being intended to cooperate, by means of a driving finger-piece (143) which it carries, with teeth (111) of the display (110).

8. The display device (100) according to claim 1, comprising a correction mechanism (150) provided with a control member configured to be kinematically linked with a corrector (153) via a train of intermediate wheels (154).

9. A watch (10) comprising a horological movement provided with a Moon phase and Earth phase display device (100) according to claim 1.
